(19) United States
(12) Patent Application Publication
(10) Pub. No.: US 2007/0115187 A1
(43) Pub. Date: May 24, 2007

(54) MOUNTING APPARATUS FOR ANTENNA

(75) Inventors: Yue-Hai Zhang, Shenzhen (CN); Lin-Yun Hong, Shenzhen (CN); Chien-Li Tsai, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,631

(22) Filed: Sep. 1, 2006

(30) Foreign Application Priority Data
Nov. 18, 2005 (CN) 200520145631.9

(51) Int. Cl. H01Q 1/24

(52) U.S. Cl. 343/702; 343/700 MS

(57) ABSTRACT

A mounting apparatus for mounting an antenna to an electronic device, includes a cover being a part of the electronic device, and a locking member is configured for mounting the antenna thereto. The locking member is made of non-conductive material and coupled to the cover.

### FIELD OF THE INVENTION

The present invention relates to mounting apparatuses, and more particularly to a mounting apparatus readily allowing installation or removal of an antenna to or from an electronic device.

### DESCRIPTION OF RELATED ART

Following the development of communication technology, especially the development of Wireless Local Area Network (WLAN) and Bluetooth, etc., many electronic devices, such as notebook computers, and mobile telephones, have the function of close range wireless telecommunication. To achieve the function, an antenna is used in an electronic device for receiving and transmitting signals. A typical antenna is directly mounted to a plastic cover of the electronic device by soldering or screws.

Following the development of alloy technology, typical covers of electronic devices are made of alloy. If an antenna is directly mounted to an alloy cover of an electronic device, the signals will be conducted to the alloy cover, which may interfere signals.

The present invention is desired to solve the above problem.

### SUMMARY OF THE INVENTION

In one preferred embodiment, a mounting apparatus for mounting an antenna to an electronic device, includes a cover being a part of the electronic device, and a locking member is configured for mounting the antenna thereto. The locking member is made of non-conductive material and coupled to the cover.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a mounting apparatus in accordance with a preferred embodiment of the present invention, together with two antennas, the mounting apparatus includes a cover, and a locking member;

FIG. 2 is a partial, enlarged view of FIG. 1;

FIG. 3 is an assembled view of the locking member and the antennas of FIG. 1; and

FIG. 4 is an assembled view of FIG. 1.

### DETAILED DESCRIPTION OF THE INVENTION

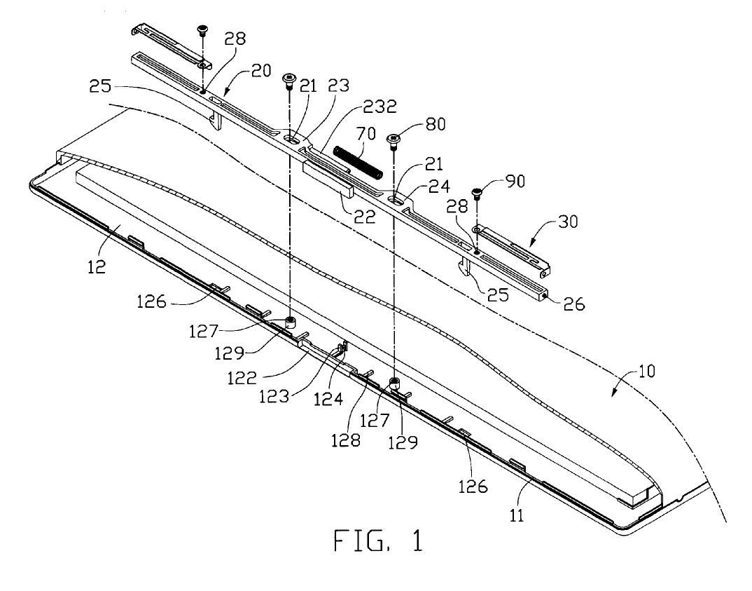

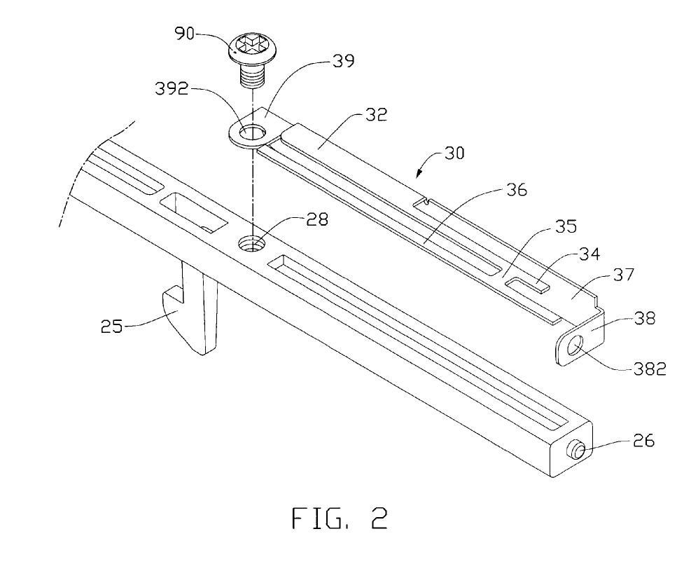

Referring to FIGS. 1 and 2, in a preferred embodiment of the present invention, a mounting apparatus for mounting two antennas 30 to an electronic device, includes a cover 12 of the electronic device, a locking member 20, a resilient member 70, two fasteners 80, and two screws 90. In the preferred embodiment, the electronic device is a notebook computer 10, and the cover 12 is made of conductive material, such as magnalium.

The cover 12 includes a flange 11 extending up from a side thereof. The flange 11 defines a notch 122 in a middle thereof. A block 123 protrudes up from the cover 12 in the vicinity of the notch 122. A U-shaped cutout 124 is defined in the block 123. Two columns 129 protrude up from the cover 12 at opposite sides of the block 123. A mounting hole 127 is defined in each column 129. Two quadrate through-holes 126 are defined in the cover 12 at opposite sides of the two columns 129. A plurality of raised portions 128 protrude up from the cover 12 along the flange 11.

The locking member 20 is made of non-conductive material, such as plastic. The locking member 20 has an elongated body. A button 22 protrudes forward from a middle portion of the body of the locking member 20. A first protrusion 23 and a second protrusion 24 protrude back from the body of the locking member 20 at opposite sides of the button 22. A pole 232 extends from the first protrusion 23 toward the second protrusion 24. Two sliding holes 21 are defined in the body of the locking member 20 in the vicinity of the first protrusion 23 and the second protrusion 24 respectively. Two hooks 25 extend down from the body of the locking member 20, corresponding to the through-holes 126 of the cover 12 respectively. A post 26 extends out from each end of the body of the locking member 20. Two mounting holes 28 are defined in the body of the locking member 20 in the vicinity of the ends of the body of the locking member 20 respectively.

Each antenna 30 includes a main portion 37, a bending portion 32 extending forward from a side of a top edge of the main portion 37, a first transmitting portion 34 extending from an end of an edge of the bending portion 32 away from the main portion 37, a second transmitting portion 36 parallel to the first transmitting portion 34, and a connecting portion 35 connected between the first and second transmitting portions 34, 36. The connecting portion 35, the first transmitting portion 34, and second transmitting portion 36 cooperatively form an H shape and are substantially coplanar with the bending portion 32. A first tab 38 extends forward from an end of the main portion 37. A first hole 382 is defined in the first tab 38. A second tab 39 extends forward from a top of the main portion 37 at an opposite end. A second hole 392 is defined in the second tab 39. The second tab 39 is lower than the first transmitting portion 34 and the second transmitting portion 36.

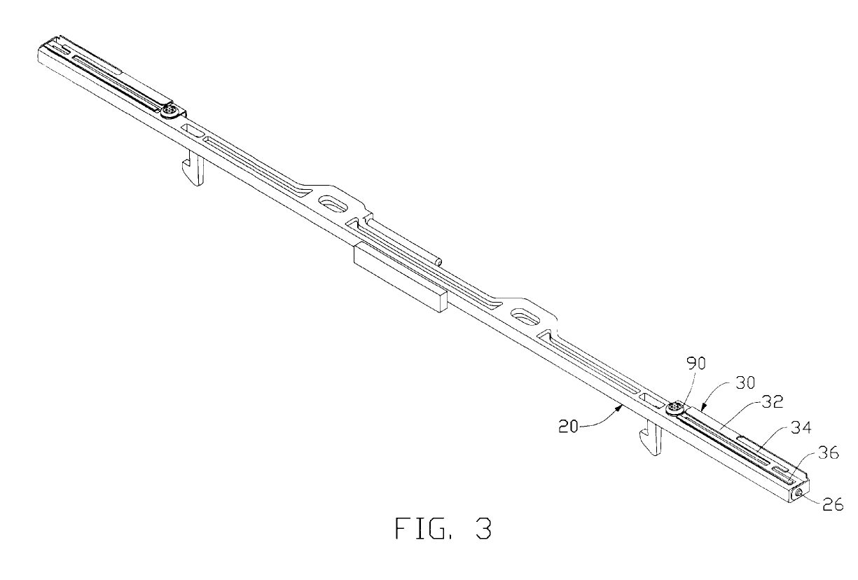

Referring also to FIG. 3, in assembling each antenna 30 to the locking member 20, the first hole 382 of the first tab 38 of the antenna 30 fits about a corresponding post 26 of the locking member 20. The main portion 37 of the antenna 30 is attached to a rear side of the locking member 20, and the first and second tabs 38, 39 are attached to the end and a top of the locking member 20 respectively. The second hole 392 of the second tab 39 is aligned with the corresponding mounting hole 28 of the locking member 20. One screw 90 extends through the second hole 392 of the second tab 39 and engages in the mounting hole 28 of the locking member 20. Thus, the antennas 30 are mounted to the locking member 20. Because the second tabs 39 of the antennas 30 are lower than the first transmitting portion 34 and the second transmitting portion 36, the first transmitting portion 34 and the second transmitting portion 36 are apart from and face the top surface of the locking member 20 for transmitting signals effectively.

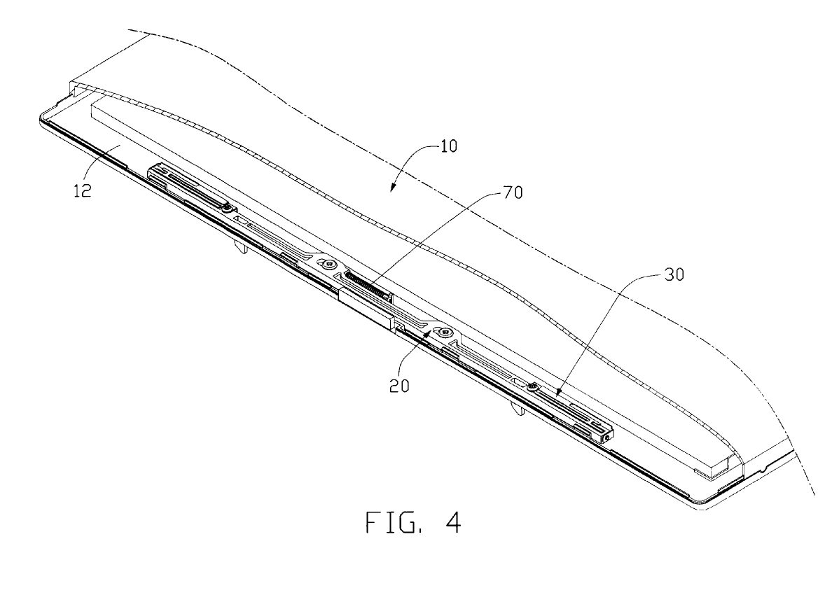

Referring also to FIG. 4, in assembling the combined assembly of the locking member 20 and the antennas 30 to the cover 12, the resilient member 70, such as a coil spring, fits about the pole 232 of the locking member 20. The body of the locking member 20 is placed on the raised portions 128 of the cover 12. The hooks 25 of the locking member 20 extend through the corresponding through-holes 126 of the cover 12. A distal end of the pole 232 of the locking member 20 is received in the cutout 124 of the block 123 of the cover 12, so that an end of the resilient member 70 is engaged with the block 123. The fasteners 80, such as two bolts, extend through the corresponding sliding holes 21 of the locking member 20 and engage in the mounting holes 127 of the corresponding columns 129 of the cover 12 respectively. The button 22 is accommodated in the notch 122 of the cover 12, for driving the locking member 20 to lock or unlock the cover 12 to or from a base of the notebook computer 10.

Because the locking member 20 is made of non-conductive material, the signals transmitted by the antenna 30 will not be conducted to the conductive material cover of the notebook computer 10, avoiding interference for receiving and transmitting signals.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A mounting apparatus for mounting an antenna to an electronic device, comprising:
a cover being a part of the electronic device; and
a locking member configured for mounting the antenna thereto, the locking member made of non-conductive material and coupled to the cover.

2. The mounting apparatus as claimed in claim 1, wherein a post protrudes out from an end of the locking member for engaging with the antenna.

3. The mounting apparatus as claimed in claim 1, wherein a mounting hole is defined in the locking member, a screw extending through the antenna and engaging in the mounting hole.

4. The mounting apparatus as claimed in claim 1, wherein the electronic device comprises a notebook computer, and the cover is a top cover of the notebook computer.

5. The mounting apparatus as claimed in claim 1, wherein the locking member is made of plastic.

6. The mounting apparatus as claimed in claim 1, wherein the cover is made of conductive material.

7. An antenna assembly comprising:
an electronic device comprising a cover;
a locking member made of non-conductive material and connected to the cover; and
an antenna mounted to the locking member.

8. The antenna assembly as claimed in claim 7, wherein the electronic device comprises a notebook computer.

9. The antenna assembly as claimed in claim 7, wherein the antenna comprises a main portion mounted to the locking member, a bending portion extending forward from a top edge of the main portion, a first transmitting portion extending from an end of a side of the bending portion away from the main portion, a second transmitting portion parallel to the first transmitting portion, and a connecting portion connected between the first and second transmitting portions.

10. The antenna assembly as claimed in claim 9, wherein a first hole is defined in the antenna at one end thereof, a post protrudes out from an end of the locking member for engaging in the first hole.

11. The antenna assembly as claimed in claim 10, wherein a second hole is defined in the antenna at an opposite end thereof, a mounting hole is defined in the locking member, a screw extends through the second hole and engages in the mounting hole.

12. The antenna assembly as claimed in claim 9, wherein the connecting portion, the first transmitting portion and second transmitting portion cooperatively form an H shape.

13. An antenna assembly comprising:
an electronic device comprising a cover made of electrically-conductive material;
a locking member made of electrically-insulative material and mounted to the cover; and
an antenna detachably mounted to the locking member.

14. The antenna assembly as claimed in claim 13, wherein one end of the antenna is mounted to the locking member via a hole-post combination and an opposite end of the antenna is mounted to the locking member via a screw.

15. The antenna assembly as claimed in claim 14, wherein the hole-post combination comprises a hole defined in one of the antenna and the locking member and a post formed at the other one of the antenna and the locking member and inserted into the hole.

16. The antenna assembly as claimed in claim 13, wherein the locking member is slidably mounted at an inside of the cover near one edge of the cover.

17. The antenna assembly as claimed in claim 13, further comprising another antenna, wherein said an antenna and said another antenna are mounted to opposite ends of the locking member respectively.
